(19) United States
(12) Patent Application Publication
(10) Pub. No.: US 2002/0159464 A1
(43) Pub. Date: Oct. 31, 2002

(54) Method of and system for providing parallel media gateway

(76) Inventor: Woodrow T. Lewis, San Carlos, CA (US)

Correspondence Address: ROZSA & CHEN, 15910 VENTURA BOULEVARD, SUITE 1601, ENCINO, CA, 91436

(21) Appl. No.: 09/844,572

(22) Filed: Apr. 25, 2001

(51) Int. Cl. H04L 12/56

(52) U.S. Cl. 370/401

(57) ABSTRACT

A method and system for providing a parallel media gateway over the Internet. The system includes a parallel media gateway protocol for providing an event driven, message oriented video stream broadcasting scheme with parallel telephony exchange of digital audio streams with self provisioning content. The method includes the steps of establishing and maintaining a server connected to the Internet and accessible by a user for receiving customized request of data streams from the user, obtaining data streams requested by the user from a stream server and providing the user with the requested data streams via the Internet, implementing a parallel media gateway protocol for adding self provisioning content in real-time to the data streams requested by the user, establishing connection with a telephony infrastructure, and enabling the user to interact with others through telephony endpoints linked to the telephony infrastructure while retrieving event driven, message oriented data streams via the Internet.

### BACKGROUND OF THE INVENTION

1. Field of the Invention

The present invention generally relates to the field of computer networking technologies and applications and more particularly, relates to multimedia broadcasting over the global computer network known as the Internet.

2. Description of the Prior Art

In recent years, there has been a great expansion of the use of global computer networks such as the Internet. As one of the important areas of development, many technologies have been introduced for multi-media broadcasting over the Internet.

The following twelve (12) prior art patents are found to be pertinent to the field of the present invention:

1. U.S. Pat. No. 5,170,252 issued to Gear et al. on Dec. 8, 1992 for “System And Method For Interconnecting And Mixing Multiple Audio And Video Data Streams Associated With Multiple Media Devices” (hereafter “Gear”);

2. U.S. Pat. No. 5,608,447 issued to Farry et al. on Mar. 4, 1997 for “Full Service Network” (hereafter “Farry”);

3. U.S. Pat. No. 5,650,994 issued to Daley on Jul. 22, 1997 for “Operation Support System For Service Creation And Network Provisioning For Video Dial Tone Networks” (hereafter “Daley”);

4. U.S. Pat. No. 5,793,770 issued to St. John et al. on Aug. 11, 1998 for “High-Performance Parallel Interface To Synchronous Optical Network Gateway” (hereafter “St. John”);

5. U.S. Pat. No. 5,856,973 issued to Thompson on Jan. 5, 1999 for “Data Multiplexing In MPEG Server To Decoder Systems” (hereafter “Thompson”);

6. U.S. Pat. No. 5,917,537 issued to Lightfoot et al. on Jun. 29, 1999 for “Level 1 Gateway For Video Dial Tone Networks” (hereafter “Lightfoot”);

7. U.S. Pat. No. 5,925,100 issued to Drewry et al. on Jul. 20, 1999 for “Client/Server System With Methods For Prefetching And Managing Semantic Objects Based On Object-Based Prefetch Primitive Present In Client's Executing Application” (hereafter “Drewry”);

8. U.S. Pat. No. 5,978,567 issued to Rebane et al. on Nov. 2, 1999 for “System For Distribution Of Interactive Multimedia And Linear Programs By Enabling Program Webs Which Include Control Scripts To Define Presentation By Client Transceiver” (hereafter “Rebane”);

9. U.S. Pat. No. 6,073,160 issued to Grantham et al. on Jun. 6, 2000 for “Document Communications Controller” (hereafter “Grantham”);

10. U.S. Pat. No. 6,085,235 issued to Clarke, Jr. et al. on Jul. 4, 2000 for “System For Parsing Multimedia Data Into Separate Channels By Network Server In According To Type Of Data And Filtering Out Unwanted Packets By Client” (hereafter “Clarke”);

11. U.S. Pat. No. 6,128,653 issued to del Val et al. on Oct. 3, 2000 for “Method And Apparatus For Communication Media Commands And Media Data Using The HTTP Protocol” (hereafter “del Val”); and

12. U.S. Pat. No. 6,151,634 issued to Glaser et al. on Nov. 21, 2000 for “Audio-On-Demand Communication System” (hereafter “Glaser”).

Gear discloses a system having a pipeline comprised of a multi-channel bi-directional video bus, multi-channel bi-directional audio bus, and a digital interprocessor communications bus. The pipeline is constructed on a motherboard printed circuit board that additionally contains a microprocessor that serves as the local area network controller for the interprocessor communications. A software driver interconnects the multiple video and audio devices in different configurations in response to user inputs to a host data processing system so that physical assignments of the device communications on the pipeline are transparent to the user. In this manner, a media device's video input and output can be optionally connected to any of the video pipes of the video bus. Similarly, the media device audio inputs and outputs can be optionally connected to any of the audio bus pipes. The pipeline is equipped with a number of ports where media controller (microprocessor) printed circuit cards can be connected, thus providing a convenient method for connecting media devices to the pipeline. The switching is accomplished through a pair of analog multiplexers whose connection options have been commanded by local microprocessor resident on the media device microprocessor control board. The local microprocessor receives instructions for the pipeline switch interconnections though the interprocessor serial communications bus.

Farry discloses a digital switching network which accommodates a full range of broadband and narrowband digital technologies, including video, wideband data, narrowband data, video-on-demand and telephone channels in an integrated manner. A Level 1 gateway is utilized to control access to all information resources on the network. A broadband ATM switch, a digital cross-connect switch or other distribution mechanisms may be utilized to interconnect information sources and subscribers. Optical fiber connects information sources to the switching component of the network utilizing a standardized transport stream.

Daley discloses an operational support system which includes service creation service activation and service control functions to provide on-line service activation for video information providers (VIPs) and video information users (VIPs) on a video dial tone network. The operational support system processes the remote request by verifying the request data with internal subscriber databases, comparing the request with available network inventory and provisioning network resources by generation requests to network elements to establish the new service. The operational support system provides an open interface for VIPs to remotely provision network resources by remotely accessing and requesting changes in corresponding VIP profiles stored in the operational support system, in order to add/delete VIP subscribers, update event schedules, and/or to download billing and usage statistics. The operational support system also is adapted to perform network creation functions including initial network configuration, logical assignment of network elements, initializing network element systems, assignment of work orders for physical interconnections, and performance verification of installed systems.

St. John discloses a digital system for providing sending and receiving gateways for HIPPI interfaces. Multiplexers route the data and overhead signals to a framer module which allocates the data and overhead signals to a plurality of 9-byte words that are arranged in a selected protocol. Electronic logic circuitry formats data signals and overhead signals in a data frame that is suitable for transmission over a connecting fiber optic link. The formatted words are stored in a storage register for output through the gateway.

Thompson discloses a method and device for communicating private application data, along with audio data (e.g., MPEG-2 encoded audio data) and video data (e.g., MPEG-2 encoded video data), from a first location to a second location. The multiplexed packets form a packet stream which is communicated to the second location. The private application data is either stuffed into a header portion of packets of encoded audio or video data, or packetized and multiplexed with packets of encoded audio or video data.

Lightfoot discloses a Level 1 gateway in advanced digital networks for providing selective point-to-point communications between subscribers terminals and broadband server equipment operated by a plurality of independent information service providers. Routing through the network is controlled by functionality identified as a level 1 Gateway. The Level 1 Gateway is itself an interactive device in that subscribers can input information and receive display information from the Gateway to define or modify their own video dial tone service through the network. It generates menus of providers, either as a function of providers available through a particular portion of the network or in a customized fashion specified by individual subscribers. It will also perform a variety of functions including communications port management of transmissions of information between subscribers and severs, processing of bulling information and session management. The Level 1 Gateway further provide a PIN number functionality, e.g. to permit parents to limit which providers their children can access.

Drewry discloses a client/server system and methods for managing object availability through semantic object “load sets”. By associating a particular “load set” with each object which might be requested by a client, improved object fetching and cache management is provided. Each “semantic object” is packaged in a “storable,” which incorporates dependency lists indicating the context in which the object is to be used (i.e., with which dependent objects). With this approach, object availability in a distributed object environment (e.g., the Internet) is improved. The related methods involve the steps for managing object fetching and discarding on a per object basis, not on a per page basis.

Rebane discloses a system and method for delivering multimedia interactive and linear programming on a large-scale network. The methods are for efficiently using system resources such as bandwidth, storage and processing time to maintain an optimally-performing system that results in minimal latency for the end-user's interaction with the system. The stored program material is segmented into portions and each program segment is transmitted to the receiving system component in less than real-time on an as-needed basis. The system is designed to be hierarchical in nature in order to avoid the huge processing and storage requirements of a system utilizing centralized storage and system control.

Grantham discloses a method and apparatus for providing a general-purpose, multifunction, individually addressable, full-bandwidth bidirectional communication device with built-in Authentication, Authorization, and Accounting (AAA) capabilities that connects a home or business user with ATM and other Switched broadband digital networks in a convenient, adaptable, extensible manner at reasonable cost. The device can be used in a heterogeneous environment and with different types of networks and protocols. The full bandwidth bi-directional communication and built-in AAA capabilities of the device distinguish it from other “set-top boxes.” The device supports a Document Services Architecture and, in particular, supports agent-based communications to ensure well-behaved communications and fair allocation of network resources among users.

Clarke discloses a system for parsing multimedia data into separate channels by network servers connected to a network. The server process examines the information packets sent from the service provider to determine zero or more of the categories that describe a content of the information packet and labels the information packets with the channel identifier associated with the respective categories prior to sending the information packets over the network. The server/control function executes a process which parses the information content sent from the service provider onto two or more channels and then broadcasts those channels over the network to a plurality of client computers.

del Val discloses a method for employing a Hypertext Transfer Protocol (HTTP protocol) for transmitting streamed digital media data from a server which is configured for coupling to a client computer via a computer network. The method includes receiving at the server form the client an HTTP POST request. The POST request requests a first portion of the digital media data and includes a request header and a request entity-body. The request entity body includes a media command for causing the first portion of the digital media data to be sent from the server to the client. The method further includes sending an HTTP response to the client from the server. The HTTP response includes a response header and a response entity body. The response entity body includes at least a portion of the first portion of the digital media data.

Glaser discloses an audio-on-demand communication system providing realtime playback of audio data transferred via telephone lines or other communication links. One or more audio servers include memory banks which store compressed audio data. High quality audio data compressed according to lossless compression techniques is transmitted together with normal quality audio data. Alternatively, metadata, or extra data, such as text, captions still images, etc., can also be transmitted with audio data and is simultaneously displayed with corresponding audio data. Furthermore, servers and subscriber PCs are dynamically allocated based upon geographic location to provide the highest possible quality in the communication link. At the request of a user at a subscriber PC, an audio server transmits the compressed audio data over the communication link to the subscriber PC. The subscriber PC receives and decompresses the transmitted audio data in less than real-time using only the processing power of the CPU within the subscriber PC. The audio-on-demand system provides a table of contents indicating significant divisions in the audio clip to be played and allows the user immediate access to audio data at the listed divisions.

While many systems and method for providing multi-media contents over a computer network system have been introduced, there are still many problems to be addressed and new needs to be satisfied.

For example, streaming video has become an important media platform. It provides a low-bandwidth proxy for the interactive television services that will enjoy wide deployment over the next few years. However, as the number of large-scale streaming events increases, a basic limitation of this platform has become apparent: public access, particularly to live events, is on a first-come, first-serve basis. While it is inherently feasible to reserve bandwidth on a private network for specific types of content, and thereby limit the absolute number of viewers, guaranteeing public access is a function of not only bandwidth but also server resources. It is therefore important to allocate these resources in a manner that identifies priority viewers wherever possible.

Recently many web sites began to offer dynamic content by allowing registered visitors to receive items such as local news stories and sports scores on personalized home pages. By specifying topics of interest, these visitors become subscribers to real-time messages broadcast by wire services and other publishers of information. This publish-subscribe paradigm has become a key element of successful Web applications.

Publish-subscribe may be used to build a priority viewer base for streaming video. Binding viewer-specific messages to the stream permits real time notification of cue points. These cue points can relate to start and stop times, as well as to meta-data describing the topical content of the multicast event. Publish-subscribe can also enable reservation of video server threads. By using viewer-specific identifiers, from the client on the software level and from the network endpoint on the hardware level, content delivery networks can offer prioritized viewing.

Multicast viewers are also a prime target market for concurrent network services, specifically telephony. Viewers in many vertical markets such as sports and entertainment are very likely to access conference call services where available. Certain real-time collaboration software currently offer concurrent data and voice conferencing, but these features have not yet been incorporated in a message-driven streaming video context.

It is desirable to provide a new method and system for providing a parallel media gateway that offers an event driven, message oriented video stream broadcasting scheme with parallel telephony exchange of digital audio streams with self provisioning content.

### SUMMARY OF THE INVENTION

The present invention is a method of and system for providing a parallel media gateway that offers an event driven, message oriented video stream broadcasting scheme with parallel telephony exchange of digital audio streams with self provisioning content.

Described generally, the present invention includes a method for providing a parallel media gateway over the Internet. The method includes the steps of establishing and maintaining a server connected to the Internet and accessible by a user at a data endpoint for receiving customized request of data streams from the user, and obtaining data streams requested by the user from a stream server also connected to the Internet, and providing the user with the requested data streams via the Internet.

The method implements a parallel media gateway protocol for ingesting meta-data tags in real-time into the data streams requested by the user, and encodes the data streams with self provisioning content in real-time. The method also provides a back channel communication between the user and the stream server over the Internet for facilitating real-time semantic search of data streams by the user.

Furthermore, the method includes the steps of establishing connection with a telephony infrastructure for receiving telephony audio signals and digitizing the audio signals, to enable the user to interact with others through telephony endpoints linked to the telephony infrastructure while retrieving event driven, message oriented data streams via the Internet.

Further novel features and other objects of the present invention will become apparent from the following detailed description, discussion and the appended claims, taken in conjunction with the drawings.

### BRIEF DESCRIPTION OF THE DRAWINGS

Referring particularly to the drawings for the purpose of illustration only and not limitation, there is illustrated:

FIG. 1 is a simplified block diagram of a system for providing a parallel media gateway via the Internet in accordance with an exemplary embodiment of the present invention;

FIG. 2 is a simplified block diagram showing a parallel media gateway platform in accordance with an exemplary embodiment of the present invention; and

FIG. 3 is a flow chart diagram that illustrates an exemplary method for providing a parallel media gateway over the Internet in accordance with an exemplary embodiment of the present invention.

### DETAILED DESCRIPTION OF THE PREFERRED EMBODIMENTS

Although specific embodiments of the present invention will now be described with reference to the drawings, it should be understood that such embodiments are by way of example only and merely illustrative of but a small number of the many possible specific embodiments which can represent applications of the principles of the present invention. Various changes and modifications obvious to one skilled in the art to which the present invention pertains are deemed to be within the spirit, scope and contemplation of the present invention as further defined in the appended claims.

The present invention is directed to a method and system for providing a parallel media gateway over the Internet, which provides a platform consisting of a parallel media gateway application server that is accessible by a browser-based client via the Internet. The server's core application program is written in the Extensible Markup Language (XML). It uses the XML-based protocol to communicate with the client. The client's interface is rendered by, for example, using Macromedia Flash 5, which has built-in XML messaging capacity.

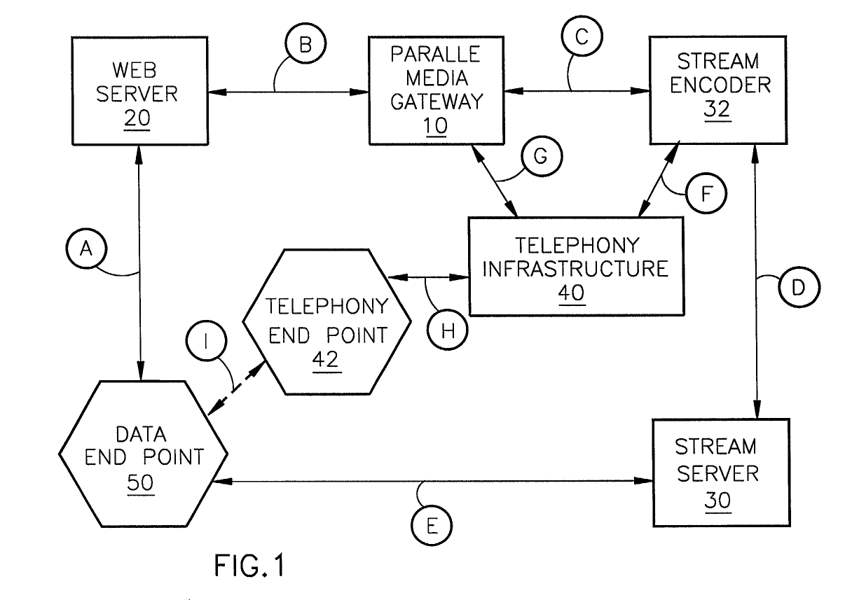

Referring to FIG. 1, there is shown a simplified block diagram of the present invention system for providing a parallel media gateway (PMG) over the Internet. The present invention PMG server 10 is connected via the Internet to a web hosting server 20, and also to a stream server 30 through a stream encoder 32. The PMG server 10 and stream encoder 32 are further connected to a telephony infrastructure 40. The telephony infrastructure 40 is connected with a multiplicity of telephone end points 42. The web server 20 is accessible via the Internet by a multiplicity of users at data end points 50.

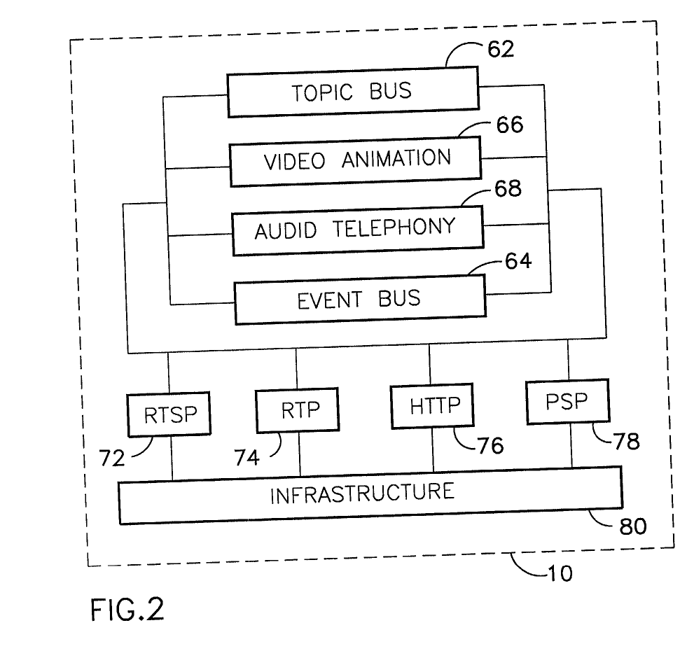

Referring to FIG. 2, there is shown a simplified block diagram of main components of the present invention PMG 10. The platform of the present invention PMG may include a topic bus 62, an event bus 64, a video animation 66 and an audio telephony 68. These components are communicating using a desired protocol 70 with an infrastructure 80. The protocol 70 used for communicating with the infrastructure 80 can be any suitable protocol, such as an (RTSP) 72, an (RTP) 74, an (HTTP) 76 or a parallel semantic protocol (PSP) 78.

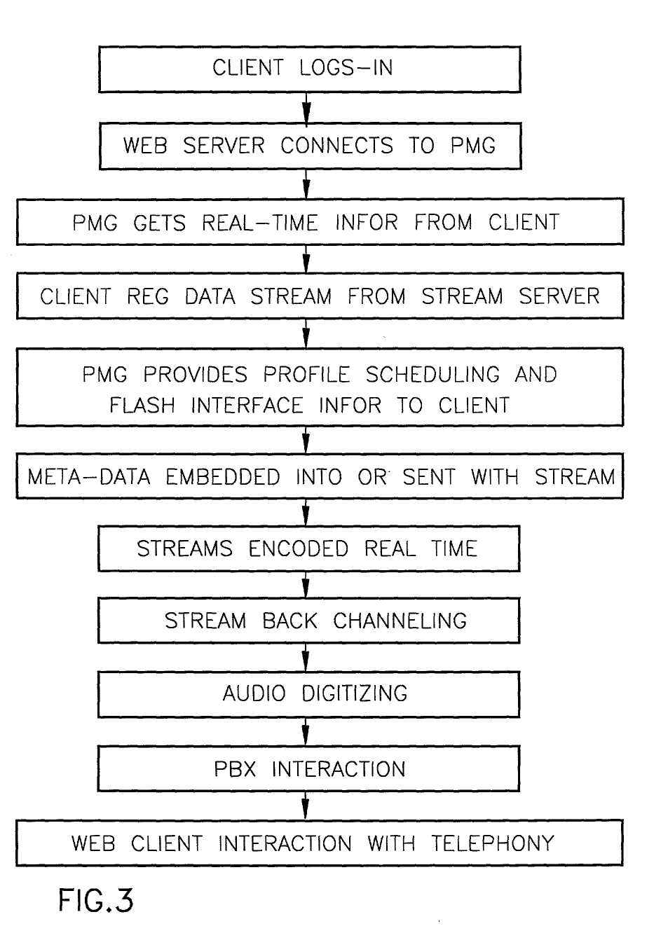

Referring to FIG. 3, there is shown the basic steps of the present invention method for providing a parallel media gateway over the Internet. Referring to FIGS. 1 and 3, the present invention method for providing a parallel media gateway includes the following steps:

A: A web client at a data end point 50 logs into web server 20. Web server 20 connects to the PMG 10 which determines the device, type, location and other realtime attributes of the client. The client also requests custom data stream from stream server 30.

B: The client receives updated profile, scheduling and Flash interface information from PMG 10. Device interface constraints part of the XML scheme and the PMG protocol.

C: Text containing meta-data are either embedded realtime into the stream or sent via a parallel stream. Data sources include text ingestion, pattern and color recognition of video, speech recognition of audio including telephony, and other third party tools. The meta-data protocol is the present invention PMG's XML-based framework.

D: Streams are encoded realtime or archives are served from the stream server 30.

E: The client communicates information regarding bandwidth and data flow directly with the stream server 30 via the Internet, which in turn traps user interaction via applications such as wordprocessors, calendaring, email, etc. It also facilitates realtime semantic search of underlying media streams and includes voice/telephonic tags by locally encoding them for addition to the stream (remote audio notation of media).

F: Audio from telephony endpoints 42 are digitized as separate files and archived for selected or multiplexed playback.

G: Audio from telephony endpoints 42 is also available at PMG 10 for retrieval by the client via the Internet.

H: The PMG 10 provides the interaction with telephony endpoint 42 through its connection with telephony infrastructure 40 of public exchange (PBX) services.

I: The PMG 10 provides user interaction between the web client at data endpoint 50 and telephony endpoint 42 when supported by endpoint features such as cell phone rings with voice/audio while embedded Web browser shows data.

The services offered by the present invention platform are in compliance with the standards and business-to-business (B2B) specifications of the Universal Description, Discovery and Integration (UDDI) Business Registry.

Complying with this standard enables the present invention PMG platform to provide a value chain with many important components, including:

1. Meta-tagging: the server can expose its ability to bind topic tags to streaming content. The server can communicate in real-time with an encoder to produce a stream capable of messaging potential viewers. Using XML and Simple Object Access Protocol (SOAP), the server can access the encoder in a transparent way.

2. Telephony: the server can integrate a message-carrying stream with telephony infrastructures to provide new application services. Potential viewers can be called automatically at certain cue points within the stream, and can make conference calls with a pre-defined list of other viewers. Internet telephony endpoints can bind with streaming media endpoints to enable prioritized, Quality of Service (QoS) conferencing while viewing the stream video. Publish-subscribe telephony network (PSTN) endpoints can be addressed by communicating with multipoint control units (MCUs) using communications protocols such as Media Gateway Control Protocol.

3. Archiving: the server can also drive selective archiving and retrieval of media assets. For example, conversations between viewers of a Webcast can be recorded as separate digital audio tracks. These tracks can be stored with the underlying video stream and tagged with meta-data enabling the selective playback of those tracks along with the stream. The filtered remarks of certain viewers can then be heard in isolation.

The present invention has many advantages. It provides an event driven, message oriented video stream broadcasting scheme with parallel telephony exchange of digital audio, i.e., the provision of parallel audio/video streams with self provisioning content.

Defined in detail, the present invention is a method for providing a parallel media gateway over a computer network, comprising the steps of: (a) establishing and maintaining a server connected to said computer network and accessible by a user at a data endpoint for ascertaining user information in real-time and receiving customized request of data streams from the user; (b) obtaining data streams requested by said user from a stream server connected to said computer network and providing said user with the requested data streams via said computer network; (c) implementing a parallel media gateway protocol for ingesting meta-data tags in real-time into said data streams requested by said user; (d) utilizing an encoder for encoding said data streams with self provisioning content in real-time; (e) providing back channel communication between said user and said stream server over said computer network for facilitating real-time semantic search of data streams by said user; (f) establishing connection with a telephony infrastructure through a public exchange service for receiving telephony audio signals, and digitizing said audio signals; (g) providing digitized audio signals in parallel to said data streams and archiving said digitized audio signals for playback; and (h) enabling said user to interact with others through telephony endpoints linked to said telephony infrastructure while retrieving event driven, message oriented data streams via said computer network.

Defined broadly, the present invention is a method for providing a parallel media gateway over a computer network, comprising the steps of: (a) establishing and maintaining a server connected to said computer network and accessible by a user at a data endpoint for receiving customized request of data streams from the user; (b) obtaining data streams requested by said user from a stream server and providing said user with the requested data streams via said computer network; (c) implementing a parallel media gateway protocol for ingesting meta-data tags in real-time into said data streams requested by said user; (d) encoding said data streams with self provisioning content in real-time; (e) providing back channel communication between said user and said stream server for facilitating real-time semantic search of data streams by said user; (f) establishing connection with a telephony infrastructure for receiving telephony audio signals and digitizing said audio signals; (g) providing digitized audio signals in parallel to said data streams; and (h) enabling said user to interact with others through telephony endpoints linked to said telephony infrastructure while retrieving event driven, message oriented data streams via said computer network.

Defined more broadly, the present invention is a method for providing a parallel media gateway over a computer network, comprising the steps of: (a) establishing and maintaining a server connected to said computer network and accessible by a user for receiving customized request of data streams from the user; (b) obtaining data streams requested by said user from a stream server and providing said user with the requested data streams via said computer network; (c) implementing a parallel media gateway protocol for adding self provisioning content in real-time to said data streams requested by said user; (d) establishing connection with a telephony infrastructure; and (e) enabling said user to interact with others through telephony endpoints linked to said telephony infrastructure while retrieving event driven, message oriented data streams via said computer network.

Of course the present invention is not intended to be restricted to any particular form or arrangement, or any specific embodiment, or any specific use, disclosed herein, since the same may be modified in various particulars or relations without departing from the spirit or scope of the claimed invention hereinabove shown and described of which the apparatus or method shown is intended only for illustration and disclosure of an operative embodiment and not to show all of the various forms or modifications in which this invention might be embodied or operated.

The present invention has been described in considerable detail in order to comply with the patent laws by providing full public disclosure of at least one of its forms. However, such detailed description is not intended in any way to limit the broad features or principles of the present invention, or the scope of the patent to be granted. Therefore, the invention is to be limited only by the scope of the appended claims.

What is claimed is:

1. A method for providing a parallel media gateway over a computer network, comprising the steps of:
a. establishing and maintaining a server connected to said computer network and accessible by a user for receiving customized request of data streams from the user;
b. obtaining data streams requested by said user from a stream server and providing said user with the requested data streams via said computer network;
c. implementing a parallel media gateway protocol for adding self provisioning content in real-time to said data streams requested by said user;
d. establishing connection with a telephony infrastructure; and
e. enabling said user to interact with others through telephony endpoints linked to said telephony infrastructure while retrieving event driven, message oriented data streams via said computer network.

2. The method in accordance with claim 1, further comprising the step of embedding meta-data tags in real-time into said data streams requested by said user.

3. The method in accordance with claim 1, further comprising the step of sending meta-data tags in parallel streams.

4. The method in accordance with claim 1, further comprising the step of encoding said data streams with said self provisioning content in real-time.

5. The method in accordance with claim 1, further comprising the step of retrieving archived data streams with self-provisioning content from said stream server.

6. The method in accordance with claim 1, further comprising the step of providing digitized audio signals in parallel to said data streams.

7. The method in accordance with claim 1, further comprising the step of digitizing said audio signals received from said telephony infrastructure.

8. The method in accordance with claim 7, further comprising the step of archiving said digitized audio signals for selected playback.

9. The method in accordance with claim 7, further comprising the step of archiving said digitized audio signals for multiplexed playback.

10. The method in accordance with claim 1, further comprising the step of providing back channel communication between said user and said stream server for facilitating real-time semantic search of data streams by said user.

11. A method for providing a parallel media gateway over a computer network, comprising the steps of:
a. establishing and maintaining a server connected to said computer network and accessible by a user at a data endpoint for receiving customized request of data streams from the user;
b. obtaining data streams requested by said user from a stream server and providing said user with the requested data streams via said computer network;
c. implementing a parallel media gateway protocol for ingesting meta-data tags in real-time into said data streams requested by said user;
d. encoding said data streams with self provisioning content in real-time;
e. providing back channel communication between said user and said stream server for facilitating real-time semantic search of data streams by said user;
f. establishing connection with a telephony infrastructure for receiving telephony audio signals and digitizing said audio signals;
g. providing digitized audio signals in parallel to said data streams; and
h. enabling said user to interact with others through telephony endpoints linked to said telephony infrastructure while retrieving event driven, message oriented data streams via said computer network.

12. The method in accordance with claim 11, further comprising the step of sending meta-data tags in parallel streams.

13. The method in accordance with claim 11, further comprising the step of retrieving archived data streams with self-provisioning content from said stream server.

14. The method in accordance with claim 11, further comprising the step of archiving said digitized audio signals for selected playback.

15. The method in accordance with claim 11, further comprising the step of archiving said digitized audio signals for multiplexed playback.

16. A method for providing a parallel media gateway over a computer network, comprising the steps of:
a. establishing and maintaining a server connected to said computer network and accessible by a user at a data endpoint for ascertaining user information in real-time and receiving customized request of data streams from the user;
b. obtaining data streams requested by said user from a stream server connected to said computer network and providing said user with the requested data streams via said computer network;
c. implementing a parallel media gateway protocol for ingesting meta-data tags in real-time into said data streams requested by said user;
d. utilizing an encoder for encoding said data streams with self provisioning content in real-time;
e. providing back channel communication between said user and said stream server over said computer network for facilitating real-time semantic search of data streams by said user;
f. establishing connection with a telephony infrastructure through a public exchange service for receiving telephony audio signals, and digitizing said audio signals;
g. providing digitized audio signals in parallel to said data streams and archiving said digitized audio signals for playback; and
h. enabling said user to interact with others through telephony endpoints linked to said telephony infrastructure while retrieving event driven, message oriented data streams via said computer network.

17. The method in accordance with claim 16, further comprising the step of sending meta-data tags in parallel streams.

18. The method in accordance with claim 16, further comprising the step of retrieving archived data streams with self-provisioning content from said stream server.

19. The method in accordance with claim 16, wherein said digitized audio signals are archived for selected playback.

20. The method in accordance with claim 17, wherein said digitized audio signals are archived for multiplexed playback.
